(19) United States
(12) Patent Application Publication
(10) Pub. No.: US 2006/0236689 A1
(43) Pub. Date: Oct. 26, 2006

(54) Apparatus and method for controlling a pump flow of heavy construction equipment

(75) Inventor: Dog Soo Kim, Changwon (KR)

Correspondence Address: LADAS & PARRY, 26 WEST 61ST STREET, NEW YORK, NY, 10023, US

(73) Assignee: VOLVO CONSTRUCTION EQUIPMENT HOLDING SWEDEN AB.

(21) Appl. No.: 11/399,555

(22) Filed: Apr. 6, 2006

(30) Foreign Application Priority Data
Apr. 20, 2005 (KR) 10-2005-32891

(51) Int. Cl. F16D 31/02

(52) U.S. Cl. 60/456

(57) ABSTRACT

Disclosed is an apparatus for controlling a pump flow of heavy construction equipment having a variable displacement pump, connected to an engine, for driving an operation device according to a manipulation amount of an operation lever, and a cooling control device for cooling hydraulic fluid by detecting a temperature of the hydraulic fluid and variably controlling the speed of a cooling fan, which can secure a rapid and efficient cooling performance by variably controlling a circulation amount of the hydraulic fluid according to the temperature of the hydraulic fluid in addition to the variable control of the speed of the cooling fan. If it is intended to stop the operation of the heavy construction equipment and to rapidly cool the hydraulic fluid due to an ambient temperature rise and an excessive rise of the temperature of the hydraulic fluid, the apparatus controls the pump flow to be maintained as much as the circulation flow required for the rapid cooling, and thus the efficient cooling of the hydraulic fluid can be achieved.

### CROSS-REFERENCE TO RELATED APPLICATION

This application is based on and claims priority from Korean Patent Application No. 10-2005-32891, filed on Apr. 20, 2005, the disclosure of which is incorporated herein in its entirety by reference.

### BACKGROUND OF THE INVENTION

1. Field of the Invention

The present invention relates to an apparatus and method for controlling a pump flow of heavy construction equipment, and more particularly, to an apparatus and method for controlling a pump flow of heavy construction equipment capable of rapidly and efficiently cooling fluid such as hydraulic fluid by controlling a discharge flow rate of a pump when it is intended to temporarily suspend operations and to rapidly cool the fluid.

2. Description of the Prior Art

Generally, when an operator manipulates an operation lever to drive heavy construction equipment, a main pump connected to an engine generates proper hydraulic fluid that corresponds to an amount of manipulation, and at the same time, a main control valve discharges the fluid at a flow rate corresponding to movement of the operation lever to drive an operation device according to an operator's intention.

In this case, a throttling or a loss due to volume efficiency occurs in a pump, a control valve, an actuator for driving an operation device, a relief valve, and others, so that energy is transformed into heat. Accordingly, the temperature of the hydraulic fluid such as hydraulic oil increases more and more by the transformed heat as the operation continues.

When the temperature of the hydraulic fluid rises over a specified limit, the characteristic of the hydraulic fluid becomes different from its initial characteristic when the corresponding hydraulic system was designed, possibly making the device and the operational efficiency damaged and degraded, respectively. To prevent this, heavy construction equipment is provided with a cooling device for cooling the hydraulic fluid such as hydraulic oil.

Recently, heavy construction equipment controls the driving of a cooling fan using an automatic control technology of varying revolution speed of the cooling fan depending upon the temperature variation of hydraulic fluid or circumferential environment, in consideration of reduction in noise and efficiency of the equipment. In cooling the fluid such as pressure oil using such a fan revolution control method for the cooling device, the heavy construction equipment controls the fan revolution speed with various control algorithms in order to maintain a target temperature of the hydraulic fluid using input parameters for the temperature and circumferential environment of the fluid.

FIG. 1 is a block diagram of a conventional apparatus for controlling a pump flow of heavy construction equipment.

As shown in FIG. 1, the conventional pump flow control apparatus 115 of heavy construction equipment is configured to control a swash plate of a main pump 114 depending upon a pilot pressure generated by a user's manipulation of an operation lever 100. Hydraulic fluid discharged from the main pump 114 drives an operation device 116, so that heat generated in the operation device 116 raises the temperature of the hydraulic fluid. The temperature-raised hydraulic fluid returns to a storage tank through a radiator. The hydraulic fluid is cooled while passing through the radiator, and the cooling efficiency is determined by the speed of a cooling fan, a temperature difference between the atmosphere and the hydraulic fluid, a circulation amount of hydraulic fluid, and others.

A cooling pan control device of the heavy construction equipment that uses an automatic control technology includes a cooling fan controller 106, a temperature sensor 110, and a cooling device 108. The cooling pan control device receives the temperature of the hydraulic fluid from the temperature sensor 110, determines the revolution speed of the cooling fan according to the received temperature using a proper algorithm, and drives the cooling fan 108 according to the determined revolution speed to cool the hydraulic fluid.

On the other hand, if the hydraulic fluid is overheated, the operator may try to cool the hydraulic fluid after temporarily stopping the operation of the heavy construction equipment. In stopping the operation of the heavy construction equipment having the cooling system in which the circulation of the hydraulic fluid is performed by the hydraulic system of the main pump 114, the flow control device 115 of the conventional heavy construction equipment controls the circulation amount of the hydraulic fluid at the minimum flow rate of the main pump 114 because there is no manipulation amount of the manipulation device. Accordingly, when the conventional heavy construction equipment stops its operation to cool the hydraulic fluid, the cooling fan revolves at a high speed due to the raised temperature of the hydraulic fluid, but the circulation amount of the hydraulic fluid passing through the cooling device is restricted to the minimum amount, and this causes problems in that the cooling efficiency of the hydraulic fluid is degraded, a noise is relatively increased, and the power consumption becomes wasteful.

### SUMMARY OF THE INVENTION

Accordingly, the present invention has been made to solve the above-mentioned problems occurring in the prior art, and an object of the present invention is to provide an apparatus and method for controlling a pump flow of heavy construction equipment capable of efficiently and rapidly cooling hydraulic fluid even in a state where the heavy construction equipment stops its operation.

In order to accomplish this object, there is provided an apparatus for controlling a pump flow of heavy construction equipment having a variable displacement pump, connected to an engine, for driving an operation device according to a manipulation amount of an operation lever, and a cooling control device for cooling hydraulic fluid by detecting a temperature of the hydraulic fluid and variably controlling the speed of a cooling fan, according to the present invention, which includes a pump displacement setting unit for setting a displacement of the variable displacement pump according to a manipulation amount of the operation lever; a circulation flow setting unit for receiving from the cooling control device a pump circulation flow signal indicating a flow rate required for an efficient cooling of the hydraulic fluid, and setting the circulation flow according to the received pump circulation flow signal; a pump displacement resetting unit for receiving the circulation flow set by the circulation flow setting unit and the pump displacement set by the pump displacement setting unit, and resetting a desired pump displacement according to the received circulation flow and the pump displacement; and a pump swash plate control unit for controlling a swash plate of the variable displacement pump according to the reset pump displacement.

In another aspect of the present invention, there is provided a method for controlling a pump flow of heavy construction equipment having an engine, a main pump for driving an operation device connected to the engine, a pump flow controller for controlling a flow rate of the main pump according to a manipulation amount of the operation device, a temperature sensor for detecting a temperature of the hydraulic fluid, and a cooling fan controller for outputting a desired revolution speed of a cooling fan according to the detected temperature of the hydraulic fluid, which includes the steps of (a) setting a circulation flow according to the detected temperature of the hydraulic fluid; (b) receiving the set circulation flow; (c) checking whether the heavy construction equipment operates; and (d) if the heavy construction equipment stops it operation, comparing the circulation flow with the pump flow according to the manipulation amount of the operation device and outputting one of the circulation flow and the pump flow, which is larger than the other as a result of comparison.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a conventional apparatus for controlling a pump flow;

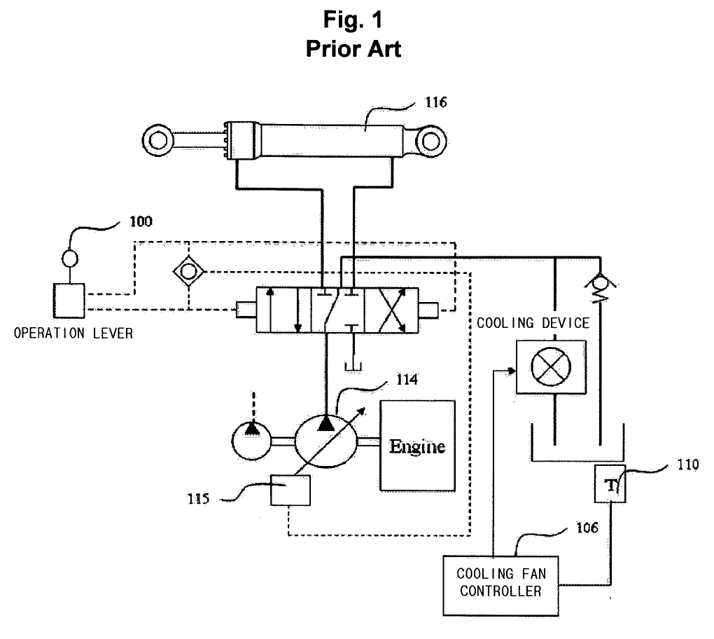

FIG. 2 is a block diagram of an apparatus for controlling a pump flow according to a first preferred embodiment of the present invention;

FIG. 3 is a block diagram of an apparatus for controlling a pump flow according to a second preferred embodiment of the present invention; and

FIG. 4 is a flowchart illustrating a process of controlling a pump flow according to a preferred embodiment of the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

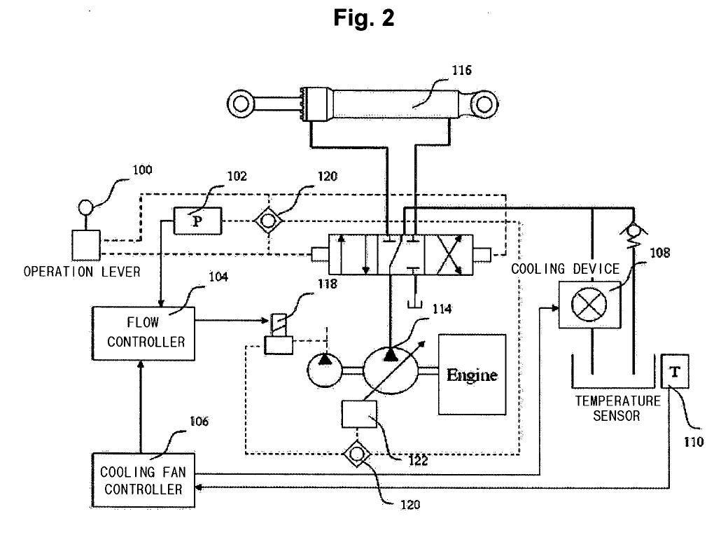

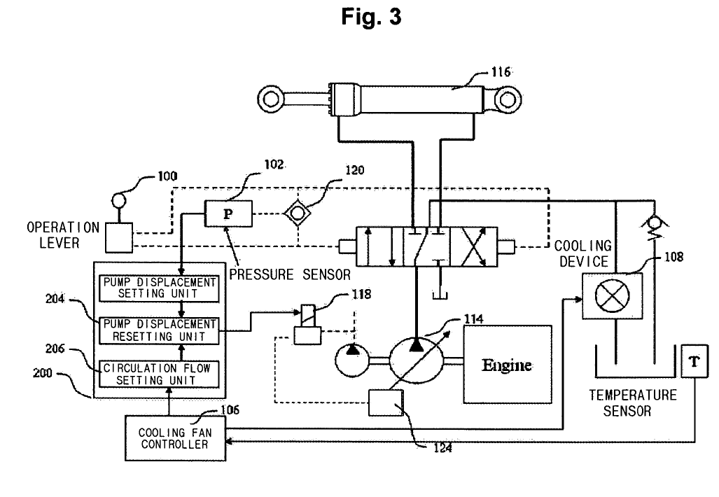

FIG. 2 is a block diagram of an apparatus for controlling a pump flow according to a first preferred embodiment of the present invention, and FIG. 3 is a block diagram of an apparatus for controlling a pump flow according to a second preferred embodiment of the present invention.

As shown in FIG. 2, the apparatus for controlling the pump flow according to the invention may include an operation lever 100, a cooling fan controller 106 (or cooling fan control unit), a flow controller 104, an electronic proportional valve 118, and a shuttle valve 120.

When an operator manipulates the operation lever 100, the secondary pressure of a remote control valve of the operation lever moves a spool of a main control valve to move an operation device 116. Simultaneously, the secondary pressure is transferred to a pump swash plate control unit 122 to control a swash plate of a main pump to set a desired pump displacement.

In accordance with a temperature detected by a temperature sensor 110 mounted on an hydraulic fluid tank, the cooling fan controller 106 controls the revolution speed of a cooling fan of the cooling device 108 in such a manner that it variably controls the revolution speed in two steps according to the temperature or in proportional to the temperature, and outputs a desired pump circulation flow to the flow controller 104. The pump circulation flow may be a signal that corresponds directly to the temperature signal or to a desirable value of the hydraulic fluid required for an efficient and rapid cooling, such as a control value of the revolution speed of the cooling fan for the cooling fan controller. The value may be calculated by the cooling fan controller, or calculated by the flow controller 104 that receives a temperature or revolution speed signal from the cooling fan controller. In any case, the desired circulation flow of the main pump can be calculated from the temperature of the hydraulic fluid. The calculated circulation flow is re-calculated into a desired displacement of the swash plate of the pump, which is to be outputted to the electronic proportional valve 118. The electronic proportional valve in turn outputs a pilot pressure that corresponds to the desired displacement of the swash plate.

The shuttle valve 120 selectively supplies one of the secondary pressure of the remote control valve attached to the operation lever 100 and the pilot pressure corresponding to the set circulation flow, which is larger than the other, to the controller 122 of the swash plate of the main pump. If the heavy construction equipment stops its operation due to the raised temperature of the hydraulic fluid, the pilot pressure set by the operation lever is set to the minimum, and the pilot pressure set by the circulation flow setting unit is set to a value above the former value, so that the main pump can discharge the circulation flow required for a rapid cooling.

In manipulating the operation lever, if the set value of the pump circulation flow is greater than the set value by the operation lever, the main control valve flow and the pump flow may not match each other to cause an excessive pressure rise and to hinder a precise operation. This problem may be avoided such that the manipulation amount of the operation lever is calculated from a signal received from a pressure sensor, and the pump circulation flow is set only when the operation lever is not manipulated.

FIG. 3 illustrates a system in which a controller 200 receives a manipulation amount of an operation lever to directly control a swash plate of a main pump, unlike the construction as illustrated in FIG. 2.

The system receives a signal from a pressure sensor 102 to calculate the manipulation amount of the operation lever and sets the desired pump displacement correspondingly. A circulation flow setting unit 206 receives a signal from the cooling fan controller 106 and calculates the circulation flow required for the rapid cooling, as illustrated in FIG. 2. A pump displacement resetting unit 204 compares the desired pump displacement set by the pump displacement setting unit with the pump displacement corresponding to the circulation flow set by the circulation flow setting unit 206, and outputs one of the pump displacement values, which is greater than the other, or outputs the pump displacement signal corresponding to the set circulation flow to the electronic proportional valve 118 if it is checked that the operation lever 100 is not manipulated, so that the swash plate of the main pump is controlled.

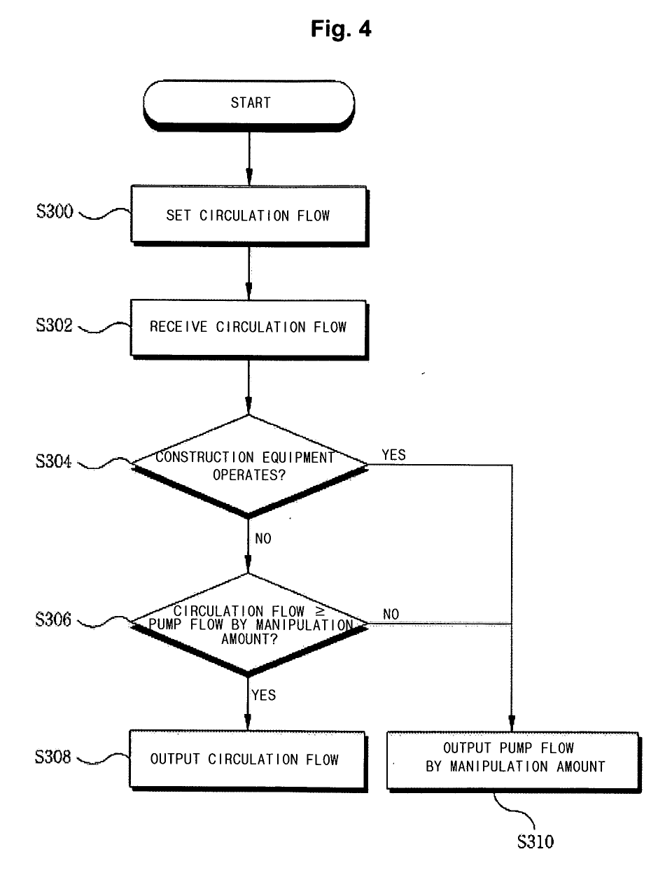

FIG. 4 is a flowchart illustrating a process of controlling a pump flow according to a preferred embodiment of the present invention.

Referring to FIG. 4, the circulation flow setting unit 206 sets a discharge amount of the hydraulic fluid having the optimum cooling efficiency according to the temperature of the hydraulic fluid detected by the temperature sensor 110 (S300).

The pump displacement resetting unit 204 receives the circulation flow outputted from the circulation flow setting unit 206 (S302), and determines whether an operation device operates (S304). That is, the operation of the operation device can be checked by the pressure signal from the pressure sensor 100 or a separate pressure switch for detecting a similar operation, the pump displacement set by the pump displacement setting unit, and others.

If it is checked that the operation device 116 operates, the pump displacement resetting unit 204 outputs the pump flow that corresponds to the manipulation amount of the operation device (S310).

By contrast, if it is checked that the operation device 116 stops its operation, the pump flow control unit 204 compares the circulation flow set by the pump flow setting unit 206 with the pump flow corresponding to the manipulation amount of the operation device (S306).

If the circulation flow is greater than the pump flow, the pump displacement resetting unit 204 outputs the circulation flow to the electronic proportional valve 118 (S308). If the pump flow corresponding to the manipulation amount of the operation device is greater than the circulation flow, the pump flow control unit 204 outputs the pump flow corresponding to the manipulation amount of the operation device to the electronic proportional valve 118 (S310). The electronic proportional valve 118 controls the discharge amount of the hydraulic fluid according to the desired flow signal outputted from the pump displacement resetting unit 204.

As described before, according to the pump flow control apparatus of the present invention, if the temperature of the hydraulic fluid of the heavy construction equipment is excessively raised and thus a rapid cooling of the hydraulic fluid is required, the circulation flow of the hydraulic fluid is controlled to have a desired circulation flow with the optimum cooling efficiency, and thus the rapid cooling of the hydraulic fluid can be performed.

Also, according to the present invention, the operation efficiency can be heightened by shortening the cooling time of the hydraulic fluid.

Also, according to the present invention, the load being applied to an engine can be rapidly reduced by heightening the cooling efficiency of the hydraulic fluid.

Although preferred embodiments of the present invention have been described for illustrative purposes, those skilled in the art will appreciate that various modifications, additions and substitutions are possible, without departing from the scope and spirit of the invention as disclosed in the accompanying claims.

1-5. (canceled)

6. An apparatus for controlling a pump flow of heavy construction equipment having a variable displacement pump, connected to an engine, for driving an operation device according to a manipulation amount of an operation lever, and a cooling control device for cooling hydraulic fluid by detecting a temperature of the hydraulic fluid and variably controlling the speed of a cooling fan, the apparatus comprising:
a pump displacement setting unit for setting a displacement of the variable displacement pump according to a manipulation amount of the operation lever;
a circulation flow setting unit for receiving from the cooling control device a pump circulation flow signal indicating a flow rate required for an efficient cooling of the hydraulic fluid, and setting the circulation flow according to the received pump circulation flow signal;
a pump displacement resetting unit for receiving the circulation flow set by the circulation flow setting unit and the pump displacement set by the pump displacement setting unit, and resetting a desired pump displacement according to the received circulation flow and the pump displacement; and
a pump swash plate control unit for controlling a swash plate of the variable displacement pump according to the reset pump displacement.

7. The apparatus as claimed in claim 6, wherein the circulation flow setting unit receives the temperature of the hydraulic fluid instead of the pump circulation flow signal from the cooling control device, and sets the pump circulation flow required for an efficient cooling of the hydraulic fluid, corresponding to the received temperature.

8. The apparatus as claimed in claim 6, wherein the pump displacement resetting unit further includes a check unit for checking whether the operation lever is manipulated, and if the check signal indicates that the operation lever is not manipulated, it sets the pump displacement to the circulation flow.

9. The apparatus as claimed in claim 6, wherein the pump displacement resetting unit receives the circulation flow set by the circulation flow setting unit and the pump displacement set by the pump displacement setting unit, resets and outputs the pump displacement so that the pump displacement is maintained over the displacement indicated by the circulation flow at least.

10. A method for controlling a pump flow of heavy construction equipment having an engine, a main pump for driving an operation device connected to the engine, a pump flow controller for controlling a flow rate of the main pump according to a manipulation amount of the operation device, and a cooling fan controller for detecting a temperature of the hydraulic fluid and outputting a desired revolution speed of a cooling fan according to the detected temperature of the hydraulic fluid, the method comprising the steps of:
(a) setting a circulation flow required for an efficient cooling according to the temperature of the hydraulic fluid or the revolution speed of the cooling fan;
(b) receiving the set circulation flow;
(c) detecting the manipulation of the operation device of the heavy construction equipment; and
(d) if the manipulation amount of the operation device is zero or smaller than a predetermined amount, discharging the pump flow by the circulation flow.
